(19) United States
(12) Patent Application Publication
(10) Pub. No.: US 2023/0134224 A1
(43) Pub. Date: May 4, 2023

(54) Network Location Service

(71) Applicants: Parallel Wireless, Inc., Nashua, NH (US); PhasorLab, Inc., Billerica, MA (US)

(72) Inventors: Prashanth Rao, Wilmington, MA (US); Joshua C. Park, Billerica, MA (US)

(21) Appl. No.: 18/046,153

(22) Filed: Oct. 12, 2022

Related U.S. Application Data
(60) Provisional application No. 63/254,731, filed on Oct. 12, 2021.

(51) Int. Cl. H04W 4/029; H04W 24/10; H04L 5/00

(52) U.S. Cl. CPC H04W 4/029; H04W 24/10; H04L 5/0051

(57) ABSTRACT

A method is disclosed of providing a 5G network location service, comprising: receiving, at a gNodeB, a measurement request from a Location Management Function (LMF) device; initiating, by the gNodeB in response to receiving the measurement request, a location determining SRS; sending, by the gNodeB, a Sounding Reference Signal (SRS) schedule to a master Hyper Speed Network (HSN) node; receiving, by the gNodeB, a message having the User equipment (UE) location; and using, by the gNodeB, the UE location as an NG-Radio Access Network (NG-RAN) Access Point location in a measurement response.

### CROSS-REFERENCE TO RELATED APPLICATIONS

The present application claims priority under 35 U.S.C. § 119(e) to U.S. Provisional Patent App. No. 63/254,731, having title “Network Location Service” and filed on Oct. 12, 2021, which is hereby incorporated by reference in its entirety for all purposes. As well, the present application hereby incorporates by reference U.S. Pat. App. Pub. Nos. US20110044285, US20140241316; WO Pat. App. Pub. No. WO2013145592A1; EP Pat. App. Pub. No. EP2773151A1; U.S. Pat. No. 8,879,416, “Heterogeneous Mesh Network and Multi-RAT Node Used Therein,” filed May 8, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/777,246, “Methods of Enabling Base Station Functionality in a User Equipment,” filed Sep. 15, 2016; U.S. patent application Ser. No. 14/289,821, “Method of Connecting Security Gateway to Mesh Network,” filed May 29, 2014; U.S. patent application Ser. No. 14/642,544, “Federated X2 Gateway,” filed Mar. 9, 2015; U.S. patent application Ser. No. 14/711,293, “Multi-Egress Backhaul,” filed May 13, 2015; U.S. Pat. App. No. 62/375,341, “S2 Proxy for Multi-Architecture Virtualization,” filed Aug. 15, 2016; U.S. patent application Ser. No. 15/132,229, “MaxMesh: Mesh Backhaul Routing,” filed Apr. 18, 2016, each in its entirety for all purposes, having attorney docket numbers PWS-71700US01, 71710US01, 71717US01, 71721US01, 71756US01, 71762US01, 71819US00, and 71820US01, respectively. This application also hereby incorporates by reference in their entirety each of the following U.S. Pat. applications or Pat. App. Publications: US20150098387A1 (PWS-71731US01); US20170055186A1 (PWS-71815US01); US20170273134A1 (PWS-71850US01); US20170272330A1 (PWS-71850US02); and Ser. No. 15/713,584 (PWS-71850US03). This application also hereby incorporates by reference in their entirety U.S. patent application Ser. No. 16/424,479, “5G Interoperability Architecture,” filed May 28, 2019; and U.S. Provisional Pat. Application No. 62/804,209, “5G Native Architecture,” filed Feb. 11, 2019. This application also hereby incorporates by reference in their entireties U.S. Pat. No. 9,048,979, “RF Carrier Synchronization and Phase Alignment Methods and Systems,” and U.S. Provisional Patent App. No. 63/196,612, “Self-Organizing Hyper Sync Network,” and U.S. Provisional Patent App. No. 63/210,349, “Self-Expanding Mesh Network for Position, Navigation, and Timing Utilizing Hyper Sync Network.”

### BACKGROUND

The ability both to locate an object and to communicate with it is a combination that enables a wide range of location-based services—from navigator-like map services to location-based advertising to tracking children, cars or even convicted criminals. Location or position detection algorithms that do not use GPS typically measure the time it takes to travel from UEs to multiple base stations.

5G positioning is a significant improvement over positioning in 3G or 4G networks, which provide only approximate positioning along x- and y-axes, while 5G positioning can also provide location data along a z-axis and may be attached to a particular device in real time.

### SUMMARY

Most algorithms require at least three base stations to cooperate to determine location. HSL does too, but instead of expensive full base stations, we augment our location coverage areas of interest with inexpensive wireless HSN-nodes that act as 5G listeners or sniffers. Thus our solution needs only one HSL-compatible gNodeB and at least 2 more HSN devices in the range of the 5G UE that we wish to track.

The sync quality between base stations (4G, 5G, and even Wi-Fi), directly impacts estimation of location quality, because the accuracy of these algorithms are limited by the speed of cellular signals, which is the same as the speed of light. In 1 ns, light will travel 0.3 meters or just under 1 foot in distance. Thus, the higher the sync quality, the better the precision.

Location precision also depends on other factors such as the localization algorithm used, degrees of freedom, density of location sensors and geometry, indoor or outdoor use, and so forth. Most 4G cell towers use GPS-trained clocks that have 15 ns of drift at minimum. Even 5G base stations that will be connected by fiber optic will experience sync errors due to routers and other equipment in the path between them that can stretch to miles. Any solution that has more than 5 ns of sync accuracy cannot do better than 1 meter in location accuracy.

A method and system for providing a network location service is described. In one embodiment, a method includes receiving, at a gNodeB, a measurement request from a Location Management Function (LMF) device; initiating, by the gNodeB in response to receiving the measurement request, a location determining SRS; sending, by the gNodeB, a Sounding Reference Signal (SRS) schedule to a master Hyper Speed Network (HSN) node; receiving, by the gNodeB, a message having the User equipment (UE) location; and using, by the gNodeB, the UE location as an NG-Radio Access Network (NG-RAN) Access Point location in a measurement response.

In another embodiment a system providing a network location service includes a gNodeB; a Location Management Function (LMF) device in communication with the gNodeB; and a master Hyper Speed Network (HSN) node in communication with the gNodeB. The gNodeB receives a measurement request from a Location Management Function (LMF) device; initiates a location determining Sounding Reference Signal (SRS); sends a Sounding Reference Signal (SRS) schedule to a master Hyper Speed Network (HSN) node; receives a message having the User equipment (UE) location; and uses UE location as an NG-Radio Access Network (NG-RAN) Access Point location in a measurement response.

### BRIEF DESCRIPTION OF THE DRAWINGS

FIG. 1 is a sequence diagram depicting a 5G network providing location information with a location service architecture, in accordance with some embodiments.

FIG. 2 is a second diagram depicting a 5G network providing location information with a location service architecture, in accordance with some embodiments.

FIG. 3 is a network diagram depicting a multi-RAT solution architecture, in accordance with some embodiments.

FIG. 4 is a schematic diagram of an enhanced gNodeB, in accordance with some embodiments.

FIG. 5 is a schematic diagram of a coordinating server, in accordance with some embodiments.

### DETAILED DESCRIPTION

The presently described system and method provide sub-meter positioning accuracy of 5G UE from PW's gNB, assisted by Phasor Lab's HyperSync Network. The deliverables for this activity are: GUI to allow user to request location of given 5G UE whose identity is specifiable by IMSI/SUPI and display location of UE on a map; allow up to 8 5G UEs to be located; the solution shall be possible with a single gNB and 4 or more HSN Nodes; Use case: Each UE location reporting action shall be initiated by PW Location Management Tool. Only one location request can be outstanding at a given time i.e. no parallel requests for location reporting will be allowed. This is a location request/response tool, not an automatic UE tracking tool.

HSN is a positioning solution that can take a waveform and produce GPS co-ordinates. There did not exist a framework until now to bring that into the ambit of a standards-based 5G network architecture. In the present application (a) We create a mechanism for the UE to generate the particular signal that HSN nodes at the time position is to be determined, convey information about the signal to the HSN network, accept GPS co-ordinates as result and then transform and report those co-ordinates in a form that is understood by 5G; and (b) We create a work flow that uses standards based messages to take user input from a GUI to locate a UE and then report the location of the UE to the GUI by using the invention of (a).

In the present disclosure HSN is used as an abbreviation to mean the PhasorLab HyperSyncNet synchronization system, as described in more detail in the documents incorporated by reference above. It is understood by the inventors that the present disclosure provides a system and method for interoperating with equivalent positioning solutions in a 4G or 5G network architecture, not merely with the HSN system.

Hardware Requirements: gNB; gNB's clock shall be disciplined by GNSS or equivalent, and/or IEEE 1588. Master HSN node shall also be disciplined by GNSS. 5G Core network simulator. Hardware to run PW's Location Management Tools may be a coordinating server, in some embodiments.

In some embodiments, a Location Services Management Tool may allow for Initiate and Display UE Location. In some embodiments, specific NRPPa message processing is performed on gNB and a Sounding Reference Signal (SRS) scheduling by gNB for Location Services. In some embodiments, a gNB Interaction with Hyper Speed Network (HSN) Master Node is provided.

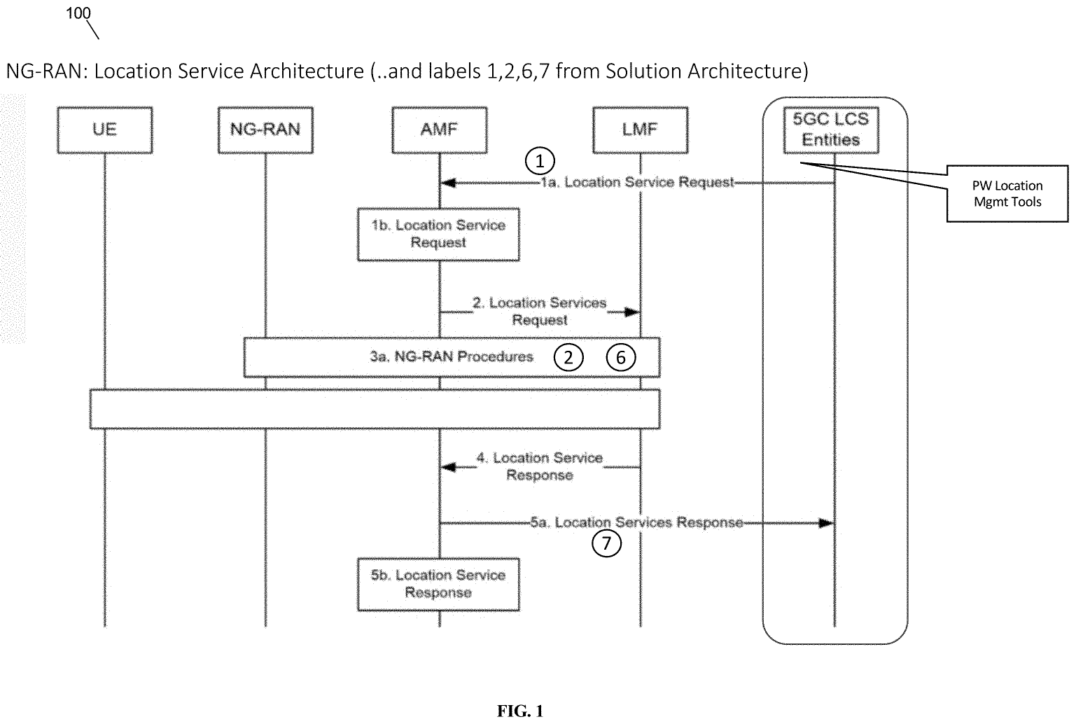

FIG. 1 is a sequence diagram depicting a 5G network providing location information with a location service architecture, in accordance with some embodiments. In the NG-RAN location service architecture, a UE, a NG-RAN (5G RAN or other equivalent), an AMF (Access and Mobility Management Function, which is an essential 5G core node, or its equivalent), a Location management function (LMF), and various location services entities (LCS entities) are provided. At step 1, a location service request or query is sent from the 5G LCS entities to the AMF, which provides the ability to query a specific UE. At step 2, the location services request is passed between the AMF and the LMF and the NG-RAN. Steps 3-5 are detailed below. At step 6, the NG-RAN returns information for calculating the location to the LMF and the LMF sends a location to the AMF. At step 7, the location services entities receive a response from the AMF. More detail is provided below.

AMF and LMF interactions may include the following. In some embodiments, an NF service consumer makes a request that includes a UE context ID, ueContextId, which represents the GUTI, or IMSI, or IMEI, or other identifier to specify the UE. Requests may be HTTP requests, in some embodiments. The request may include a specific identifier to specify the UE, in some embodiments. The request may request and return a location estimate, an accuracy parameter, an age of the location estimate, a velocity estimate, a civic address, an altitude, a latitude and longitude, or other location information associated with the UE, in some embodiments. Error messaging may be provided using HTTP 400/500 error codes, in some embodiments. Further information about the specific messaging is provided in 3GPP TS 29.572 version 16.6.0, hereby incorporated by reference in its entirety. Lawful intercept or government entities may be permitted to query location, in some embodiments.

LMF and gNB interactions may include the following. In some embodiments, the LMF may be configured to intercept an E-CID (enhanced cell ID) measurement initiation request/response protocol to determine the location of the UE, and instead of using the location of the gNB, the E-CID request may be used as a trigger to initiate a location based SRS, e.g., performing an SRS procedure for the specific purpose of determining the UE's location, further described below, and the actual location of the UE may be inserted in the response to the E-CID request. In some embodiments the UE's location info may be inserted into the information element (IE) for NG-RAN Access Point Location, which ordinarily includes the configured estimated geographical position of the antenna of the cell.

The Sounding Reference Signal (SRS) is a reference signal transmitted by the UE in the uplink direction which is used by the eNodeB to estimate the uplink channel quality over a wider bandwidth. The eNodeB may use this information for uplink frequency selective scheduling. The eNodeB can also use SRS for uplink timing estimation as part of timing alignment procedure, particularly in situations like there are no PUSCH/PUCCH transmissions occurring in the uplink for a long time.

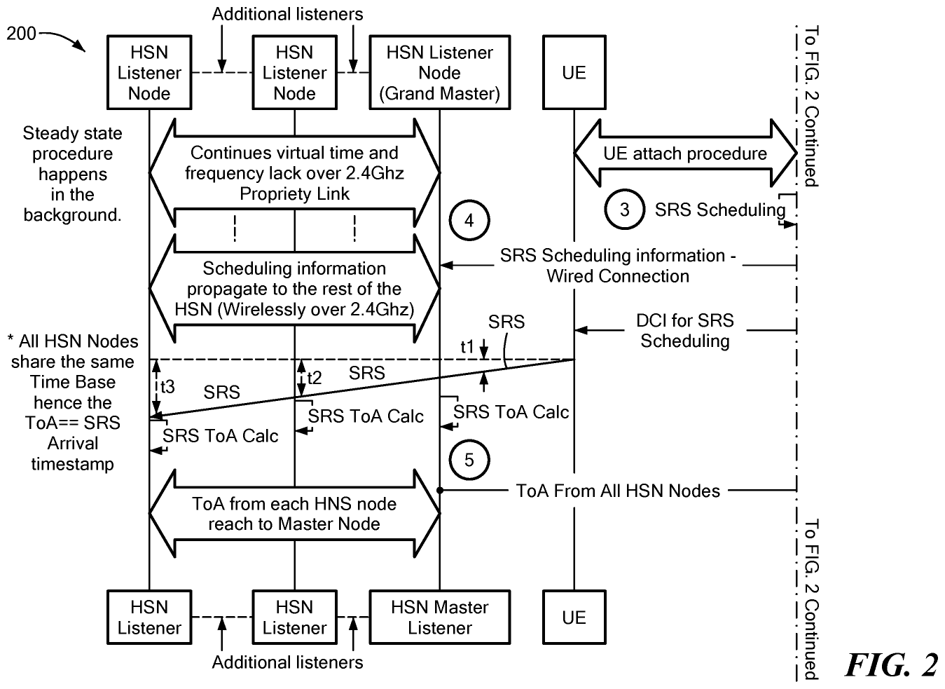

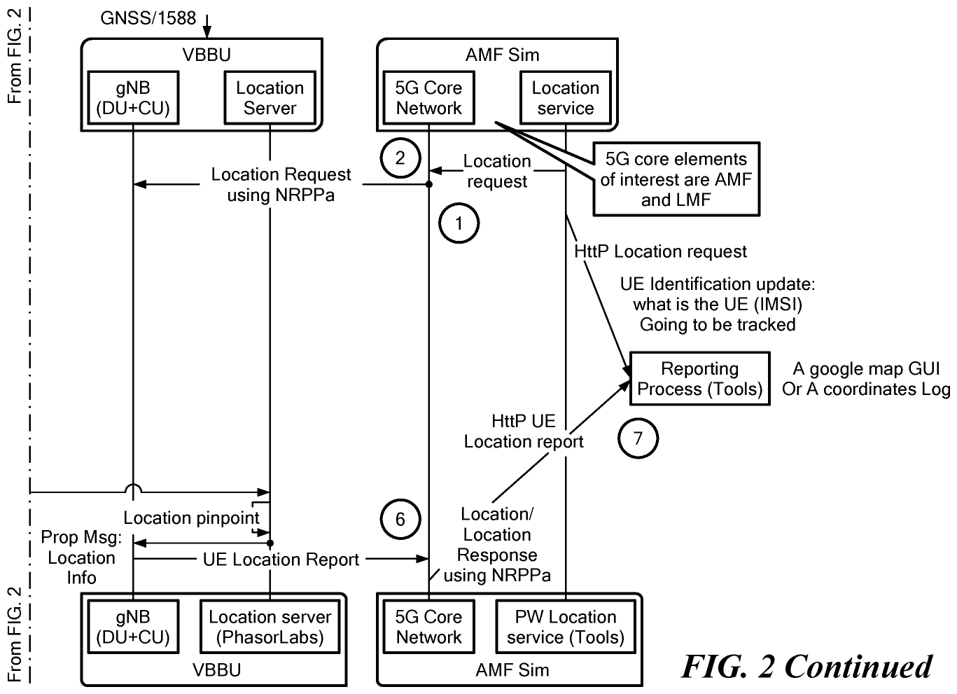

The following relates to steps 2 and 7 in FIGS. 1 and 2. gNB procedures that may be NRPPa (NR (New Radio) Positioning Protocol A) related may be as follows, in some embodiments. gNB may implement NRPPa message handling for ECID Measurement Procedures. ECID Measurement Request comes from LMF, which is further described in 3GPP TS 29.572 V15.1.0, hereby incorporated by reference. gNB shall not initiate ECID measurement. Rather, this shall be the trigger for initiating Location Based SRS. gNB sends SRS schedule to Master HSN Node. gNB shall wait for the Phasor Labs' SW (running on vBBU) to send a message to it with UE location as a Geographic (latitude, longitude) co-ordinates and Altitude. The message may contain the following elements:

```
{
  TransactionID; // ties with request
  LocationInfo;
  Altitude
}
```

gNB procedures SRS related. Upon receipt of UE's location info, gNB shall use this location as the NG-RAN Access Point Location in the ECID Measurement Response. It shall also set Timing Advance to 0 in order to make the “NG-RAN Access Point Location” identical to UE's reported location.

At step 3, gNB shall set up a dedicated SRS-Resource Set for location services. This SRS-Resource Set shall be aperiodic. Single port transmission and non-codebook. Freq hopping disabled. Single BW part.

In order to absorb HSN<-> gNB communication delays, gNB shall schedule SRS at least 500 ms after but before 1 s after receiving the ECID measurement request over NG-C.

gNB scheduler shall pre-empt, if needed, all other UL transmissions on Location Services SRS resources.

gNB scheduler shall send a message with the following meta data to the Master HSN Node:

```
{
  TransactionID,
  UL carrier frequency, //MHz 6 decimal places
  UL BW,
  Location Services SRS start slot time in UTC,
  // aligned to 10ms boundary of GNSS time
  SRS Start RB, SRS BW,
  SRS symbol location, // bitmap of 14, symbol(s) in a slot
  Number of consecutive Slots,
}
```

gNB procedures SRS related. At first pass, SRS power shall be controlled by OLPC and simply setting nominal SRS power high. If simple SRS power setting is not adequate for performance, a basic SRS closed loop power control shall be setup to ensure that UE transmits at max power during Location Services SRS by configuring PHR reporting on SRS. Only 1 UE shall be the target of Location Reporting at any given time.

gNB procedures configuration and interaction with HSN master node. (Step 4, Step 5)

Configuration: gNB shall have a file based configuration of the IP address/URL of the Master HSN Node. gNB shall read Location SRS parameters from file. gNB shall read SRS Power Control parameters from file, in some embodiments.

HSN Interaction: gNB shall send a IP based proprietary message containing the Location Services SRS meta data discussed previously to the Master HSN Node after receiving the NRLPPa Measurement Request, in some embodiments.

HSN Interaction: gNB NRLPPa module shall implement a listener for IP packets that brings the results of precision UE Location Request from the HSN Master Node, in some embodiments.

gNB shall operate at 30 khz carrier spacing and BW of 100 Mhz, in some embodiments.

Further procedures may be as specified in 3GPP TS 38.455 V15.0.0, which is hereby incorporated by reference.

FIG. 2 is a second diagram depicting a 5G network providing location information with a location service architecture, in accordance with some embodiments. Steps 1 and 2 are shown in FIG. 1. The gNB is shown as using a virtualized baseband unit (VBBU), but may be another configuration of BBU, in some embodiments. At step 3, SRS scheduling is performed at the gNB itself. Once the SRS is performed with the UE, at step 4, the SRS scheduling information is sent over an extremely low latency and/or wired connection to a HSN node, which observes the phase and timing of the SRS information. This scheduling information is shared with 2 other HSN nodes, in some embodiments, which are already in sync to single digit nanoseconds and whose location is known to high accuracy, according to methods described elsewhere herein and as incorporated by reference. As shown in FIG. 2, the propagation time to each of the other HSN nodes is taken into account and the HSN nodes each share the same time base hence the time of arrival calculation of the SRS information is taken into account. This time of arrival for the different HSN nodes is used to calculate location of the UE to high precision, at step 5, at the location server colocated with the gNB, in some embodiments. This location calculation step may be performed at an HSN node or at a coordinating server or at another location, in some embodiments. The location server then sends a UE location report, at step 6, to the LMF and the and the location report is sent to the reporting process, which may be a Google Map, GUI, command line, JSON endpoint, etc.

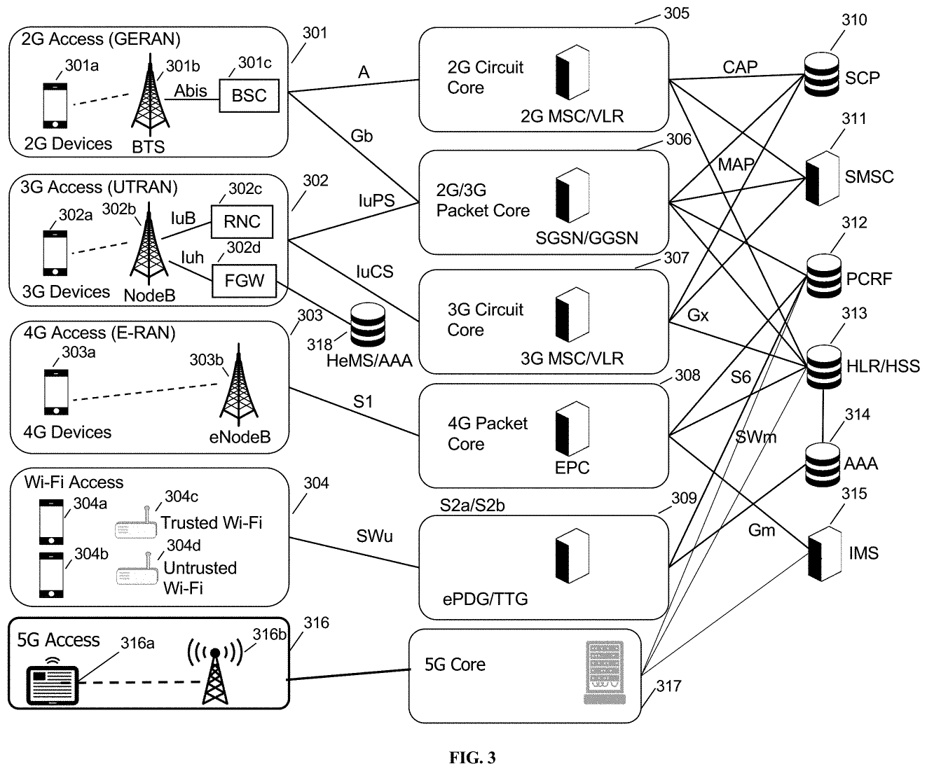

FIG. 3 is a network diagram depicting a multi-RAT solution architecture, in accordance with some embodiments. The diagram shows a plurality of “Gs,” including 2G, 3G, 4G, 5G and Wi-Fi. 2G is represented by GERAN 301, which includes a 2G device 301a, BTS 301b, and BSC 301c. 3G is represented by UTRAN 302, which includes a 3G UE 302a, nodeB 302b, RNC 302c, and femto gateway (FGW, which in 3GPP namespace is also known as a Home nodeB Gateway or HNBGW) 302d. 4G is represented by EUTRAN or E-RAN 303, which includes an LTE UE 303a and LTE eNodeB 303b. Wi-Fi is represented by Wi-Fi access network 304, which includes a trusted Wi-Fi access point 304c and an untrusted Wi-Fi access point 304d. The Wi-Fi devices 304a and 304b may access either AP 304c or 304d. In the current network architecture, each “G” has a core network. 2G circuit core network 305 includes a 2G MSC/VLR; 2G/3G packet core network 306 includes an SGSN/GGSN (for EDGE or UMTS packet traffic); 3G circuit core 307 includes a 3G MSC/VLR; 4G circuit core 308 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 330, the SMSC 331, PCRF 332, HLR/HSS 333, Authentication, Authorization, and Accounting server (AAA) 334, and IP Multimedia Subsystem (IMS) 335. An HeMS/AAA 336 is present in some cases for use by the 3G UTRAN. The diagram is used to indicate schematically the basic functions of each network as known to one of skill in the art, and is not intended to be exhaustive. For example, 5G core 317 is shown using a single interface to 5G access 316, although in some cases 5G access can be supported using dual connectivity or via a non-standalone deployment architecture.

Noteworthy is that the RANs 301, 302, 303, 304 and 336 rely on specialized core networks 305, 306, 307, 308, 309, 337 but share essential management databases 330, 331, 332, 333, 334, 335, 338. More specifically, for the 2G GERAN, a BSC 301c is required for Abis compatibility with BTS 301b, while for the 3G UTRAN, an RNC 302c is required for Iub compatibility and an FGW 302d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

The system may include 5G equipment. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

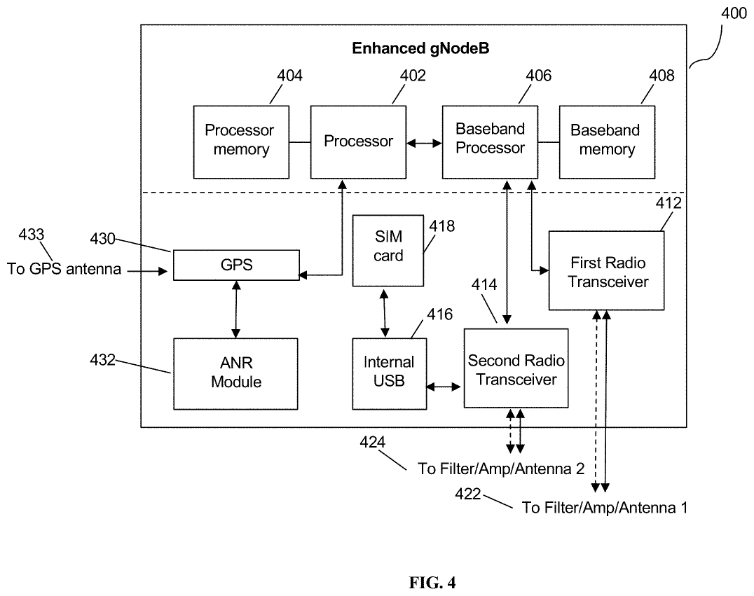

FIG. 4 is a schematic diagram of an enhanced gNodeB, in accordance with some embodiments. eNodeB 400 may include processor 402, processor memory 404 in communication with the processor, baseband processor 406, and baseband processor memory 408 in communication with the baseband processor. Mesh network node 400 may also include first radio transceiver 412 and second radio transceiver 414, internal universal serial bus (USB) port 416, and subscriber information module card (SIM card) 418 coupled to USB port 416. In some embodiments, the second radio transceiver 414 itself may be coupled to USB port 416, and communications from the baseband processor may be passed through USB port 416. The second radio transceiver may be used for wirelessly backhauling eNodeB 400.

Processor 402 and baseband processor 406 are in communication with one another. Processor 402 may perform routing functions, and may determine if/when a switch in network configuration is needed. Baseband processor 406 may generate and receive radio signals for both radio transceivers 412 and 414, based on instructions from processor 402. In some embodiments, processors 402 and 406 may be on the same physical logic board. In other embodiments, they may be on separate logic boards.

Processor 402 may identify the appropriate network configuration, and may perform routing of packets from one network interface to another accordingly. Processor 402 may use memory 404, in particular to store a routing table to be used for routing packets. Baseband processor 406 may perform operations to generate the radio frequency signals for transmission or retransmission by both transceivers 410 and 412. Baseband processor 406 may also perform operations to decode signals received by transceivers 412 and 414. Baseband processor 406 may use memory 408 to perform these tasks.

The first radio transceiver 412 may be a radio transceiver capable of providing LTE eNodeB functionality, and may be capable of higher power and multi-channel OFDMA. The second radio transceiver 414 may be a radio transceiver capable of providing LTE UE functionality. Both transceivers 412 and 414 may be capable of receiving and transmitting on one or more LTE bands. In some embodiments, either or both of transceivers 412 and 414 may be capable of providing both LTE eNodeB and LTE UE functionality. Transceiver 412 may be coupled to processor 402 via a Peripheral Component Interconnect-Express (PCI-E) bus, and/or via a daughtercard. As transceiver 414 is for providing LTE UE functionality, in effect emulating a user equipment, it may be connected via the same or different PCI-E bus, or by a USB bus, and may also be coupled to SIM card 418. First transceiver 412 may be coupled to first radio frequency (RF) chain (filter, amplifier, antenna) 422, and second transceiver 414 may be coupled to second RF chain (filter, amplifier, antenna) 424.

SIM card 418 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 400 is not an ordinary UE but instead is a special UE for providing backhaul to device 400.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 412 and 414, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 402 for reconfiguration.

A GPS module 430 may also be included, and may be in communication with a GPS antenna 432 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 432 may also be present and may run on processor 402 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

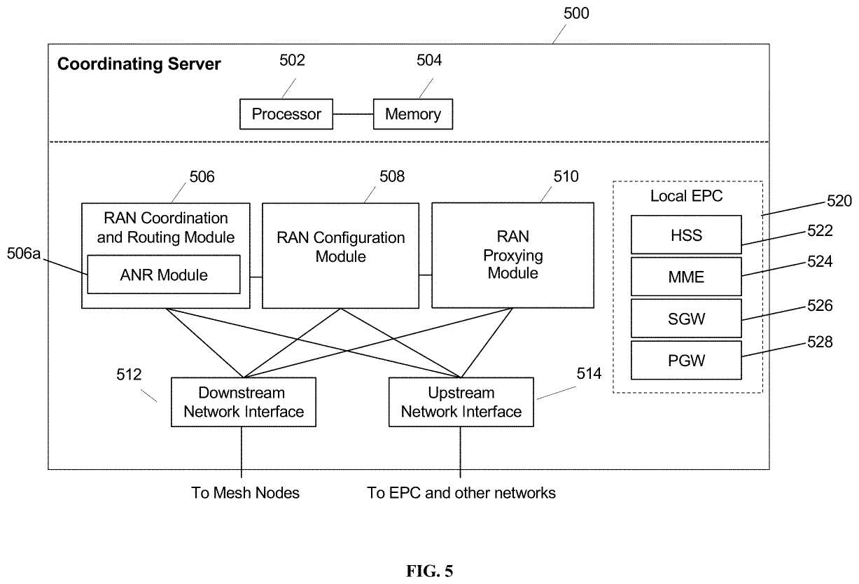

FIG. 5 is a schematic diagram of a coordinating server, in accordance with some embodiments. Coordinating server 500 includes processor 502 and memory 504, which are configured to provide the functions described herein. Also present are radio access network coordination/routing (RAN Coordination and routing) module 506, including ANR module 506a, RAN configuration module 508, and RAN proxying module 510. The ANR module 506a may perform the ANR tracking, PCI disambiguation, ECGI requesting, and GPS coalescing and tracking as described herein, in coordination with RAN coordination module 506 (e.g., for requesting ECGIs, etc.). In some embodiments, coordinating server 500 may coordinate multiple RANs using coordination module 506. In some embodiments, coordination server may also provide proxying, routing virtualization and RAN virtualization, via modules 510 and 508. In some embodiments, a downstream network interface 512 is provided for interfacing with the RANs, which may be a radio interface (e.g., LTE), and an upstream network interface 514 is provided for interfacing with the core network, which may be either a radio interface (e.g., LTE) or a wired interface (e.g., Ethernet).

Coordinator 500 includes local evolved packet core (EPC) module 520, for authenticating users, storing and caching priority profile information, and performing other EPC-dependent functions when no backhaul link is available. Local EPC 520 may include local HSS 522, local MME 524, local SGW 526, and local PGW 528, as well as other modules. Local EPC 520 may incorporate these modules as software modules, processes, or containers. Local EPC 520 may alternatively incorporate these modules as a small number of monolithic software processes. Modules 506, 508, 510 and local EPC 520 may each run on processor 502 or on another processor, or may be located within another device.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server, when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than S1AP, or the same protocol, could be used, in some embodiments.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

In some embodiments, the software needed for implementing the methods and procedures described herein may be implemented in a high level procedural or an object-oriented language such as C, C++, C #, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method of providing a network location service, comprising:
receiving, at a gNodeB, a measurement request from a Location Management Function (LMF) device;
initiating, by the gNodeB in response to receiving the measurement request, a location determining SRS;
sending, by the gNodeB, a Sounding Reference Signal (SRS) schedule to a master Hyper Speed Network (HSN) node;
receiving, by the gNodeB, a message having the User equipment (UE) location; and
using, by the gNodeB, the UE location as an NG-Radio Access Network (NG-RAN) Access Point location in a measurement response.

2. A system providing a network location service, comprising:
a gNodeB;
a Location Management Function (LMF) device in communication with the gNodeB;
a master Hyper Speed Network (HSN) node in communication with the gNodeB;
wherein the gNodeB receives a measurement request from a Location Management Function (LMF) device; initiates a location determining Sounding Reference Signal (SRS); sends a Sounding Reference Signal (SRS) schedule to a master Hyper Speed Network (HSN) node; receives a message having the User equipment (UE) location; and uses UE location as an NG-Radio Access Network (NG-RAN) Access Point location in a measurement response.
